(19) United States
(12) Patent Application Publication
(10) Pub. No.: US 2006/0015623 A1
(43) Pub. Date: Jan. 19, 2006

(54) Communication method and server computer

(76) Inventor: Hirofumi Iori, Chikushi-gun (JP)

Correspondence Address: JORDAN AND HAMBURG LLP, 122 EAST 42ND STREET, SUITE 4000, NEW YORK, NY, 10168, US

(21) Appl. No.: 11/179,417

(22) Filed: Jul. 12, 2005

(30) Foreign Application Priority Data
Jul. 13, 2004 (JP) 2004-206460

(51) Int. Cl. G06F 15/16

(52) U.S. Cl. 709/227

(57) ABSTRACT

The present invention provides a communication method which enables the smooth communication between a server computer and a client computer without being influenced by a use environment. In communication method which is performed between a server computer and a client computer which are connected with each other via an electronic communication network, a request signal is transmitted from the client computer to the server computer using an application allocated to a specific port number, and any one of a plurality of application programs allocated to a port number identical with the specific port number is transmitted from the server computer which receives the request signal to the client computer using the port number, and the communication between the server computer and the client computer is performed using the application program.

### BACKGROUND OF THE INVENTION

The present invention relates to a communication method performed between a server computer and a client computer which are communicated with each other via an electronic communication network.

Recently, between a server computer and a client computer, a communication which uses various applications such as web browser, file transfer and remote control has been popularly performed using an electronic communication network as represented by Internet.

Conventionally, in performing the communication using various applications, preset port numbers are allocated to the respective applications. For example, a port number 80 is used when the web browser is performed, a port number 21 is used when the file transfer is performed, and the port number 3389 is used when the remote control is performed.

### SUMMARY OF THE INVENTION

In this manner, in the related art, to perform the communication using various applications between the server computer and the client computer, each time one of such applications is used, it is necessary to use the given port number allocated to such an application.

Accordingly, in the related art, under the limited use environment of the server computer and the client computer where only a specific port number can be used, only the application which corresponds to the specific port number can be used and hence, it is difficult to establish the smooth communication between the server computer and the client computer. To consider such a situation from the server computer side, this implies that the server computer cannot provide the sufficient services to the client computer. On the other hand, to consider such a situation from the client computer side, this implies that the client computer cannot receive the offer of the sufficient services from the server computer.

According to a first aspect of the present invention, there is provided a communication method which is performed between a server computer and a client computer which are connected with each other via an electronic communication network, wherein the communication method includes the steps of transmitting a request signal from the client computer to the server computer using an application allocated to a specific port number, and transmitting any one of a plurality of application programs allocated to a port number identical with the specific port number from the server computer which receives the request signal to the client computer using the port number, and performing the communication between the server computer and the client computer using the application program.

Further, according to a second aspect of the present invention, there is provided a server computer which performs a communication with a client computer which is connected with the server via an electronic communication network, wherein when the server computer receives a request signal using an application allocated to a specific port number from the client computer, any application program out of a plurality of application programs allocated to a port number identical with the specific port number is transmitted to the client computer, and the server computer performs a communication with the client computer using the application program.

According to the present invention, when the request signal is transmitted to the server computer using the application allocated to the specific port number from the client computer, the communication between the server computer and the client computer is performed using the application program which is allocated to the port number identical with the specific port number. Accordingly, even under an environment where the use environment of the server computer and the client computer is restricted and hence, only the specific port number can be used, it is possible to make use of various applications using such a specific port number whereby it is possible to perform the smooth communication between the server computer and the client computer.

### BRIEF DESCRIPTION OF THE SEVERAL VIEWS OF THE DRAWING

FIG. 1 is an explanatory view showing a server computer and a client computer which are connected with each other via an electronic communication network; and

FIG. 2 is a schematic view showing the transmission and reception of signals, program, file and the like between the server computer and server computer.

### DETAILED DESCRIPTION OF THE INVENTION

A communication method according to the present invention is a communication method which is performed between a server computer and a client computer which are connected with each other via an electronic communication network.

Further, according to the communication method of the present invention, first of all, the client computer transmits a request signal to a server computer using an application which is allocated to a specific port number.

Next, the server computer which receives the request signal from the client computer transmits a corresponding application program out of a plurality of application programs allocated to a port number identical with the above-mentioned specific port number to the client computer using the specific port number.

Then, the communication is performed between the server computer and the client computer using the application program.

To consider such communication with respect to the server computer, upon receiving the request signal from the client computer using the application program allocated to the specific port number, the server computer transmits the corresponding application program out of a plurality of application programs allocated to the port number identical with the specific port number using the port number, and performs the communication with the client computer using the application program.

In this manner, according to the present invention, when the request signal is transmitted to the server computer using the application which is allocated to the specific port number from the client computer, the communication between the server computer and the client computer is performed using the application program allocated to the port number identical with the specific port number.

Accordingly, even under an environment where the use environment of the server computer and the client computer is restricted and hence, only the specific port number can be used, it is possible to make use of various applications using such a specific port number whereby it is possible to perform the smooth communication between the server computer and the client computer.

To consider such a situation from the server computer side, this implies that the server computer can provide the sufficient services to the client computer. On the other hand, to consider such a situation from the client computer side, this implies that the client computer can receive the offer of the sufficient services from the server computer.

For example, when the request signal which requests the file transfer using a FTP (File Transfer Protocol) which is an application for file transfer is transmitted from the client computer to the server computer using a HTTP (Hyper Text Transfer Protocol) which is an application for web browser of the port number 80, the server computer transmits a file transfer program which is set to allow the client computer to perform the transfer of the file using the port number 80 different from the usual port number 21, and the file transfer is performed between the server computer and the client computer using the file transfer program using the port number 80.

Accordingly, even when the server computer and the client computer are allowed to use only the port number 80, it is possible to use not only the application for web browser corresponding to the port number 80 but also the application for file transfer. In other words, the server computer and the client computer can freely perform the mutual communication without being conscious of the respective use environments at all.

A communication method according to the present invention is specifically explained in conjunction with drawings.

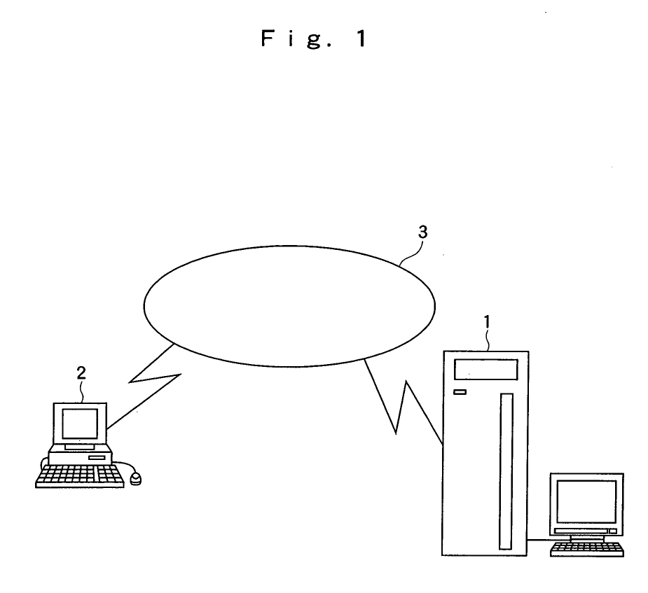

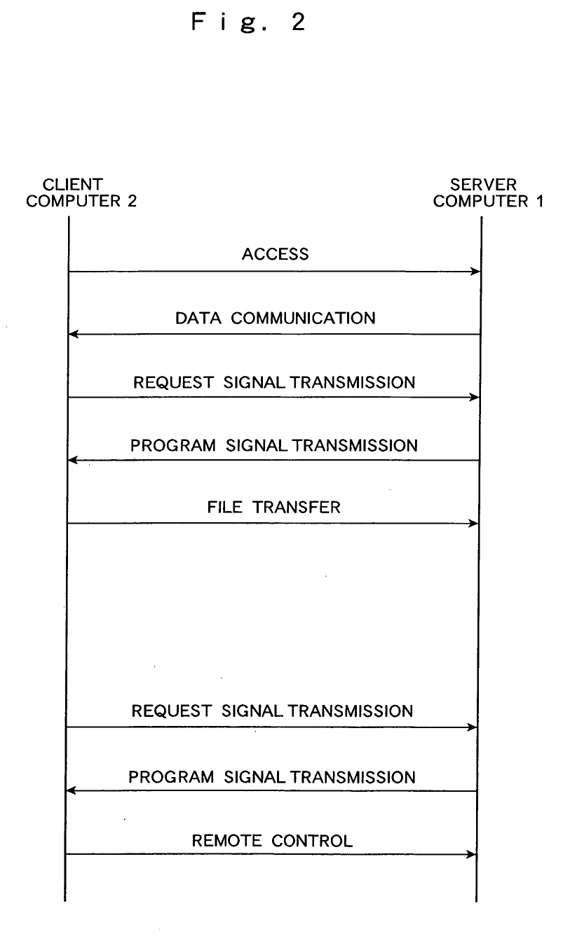

A communication system according to the present invention, as shown in FIG. 1, performs the communication between a server computer 1 and a client computer 2 under an environment (see FIG. 2) where the server computer 1 and the client computer 2 are connected with each other via an electronic communication network 3 as represented by the Internet (see FIG. 1).

In such an environment where the server computer 1 and the client computer 2 are connected with each other via the electronic communication network 3, when a client wants to browse a home page of the server, the client computer 2 gets access to the server computer 1 using the port number 80 with a browser software installed in the client computer 2.

The server computer 1 which receives the access transmits hyper text data for home page to the client computer 2 using the port number 80.

The client computer 2 which receives the data displays contents of the hyper text data using the browser software.

Then, when the clients wants to use a specific application in the home page of the server, for example, the file transfer or the remote control, in response to the clicking of a given icon on the home page of the server, the client can transmit a request signal to the server computer 1 from the client computer 2 using the port number 80. Here, the explanation is made with respect to the case in which the client requests the use of the application of file transfer.

In the server computer 1 which receives the request signal, plural kinds of application programs such as the file transfer, remote control and the like which are allocated to the port number 80 are prepared. Among the plural kinds of the application programs, the server computer 1 selects the application program which performs the file transfer corresponding to the request signal from the client computer 2 and transmits the selected application program to the client computer 2 using the port number 80.

The client starts the application program which is received using the client computer 2 and performs the file transfer using the application program. Here, although the port number 21 is used for the application program which performs the usual file transfer, the application program which performs the file transfer transmitted from the server computer 1 does not use the port number 21 but uses the port number 80, that is, the port number which the client computer 2 uses at the time of transmitting the request signal.

Next, when the client wants to use the remote control in a home page of the server as other application program, when the client clicks an icon for remote control in the home page of the server, the request signal is transmitted to the server computer 1 from the client computer 2 using the port number 80.

The server computer 1 which receives the request signal, among the plural kinds of the application programs, selects the application program which performs the remote control corresponding to the request signal from the client computer 2 and transmits the selected application program to the client computer 2 using the port number 80.

The client starts the application program which is received using the client computer 2 and performs the remote control using the application program. Here, although the port number 3389 is used for the application program which performs the usual remote control, the application program which performs the remote control transmitted from the server computer 1 does not use the port number 3389 but uses the port number 80, that is, the port number which the client computer 2 uses at the time of transmitting the request signal.

As has been explained above, when the request signal is transmitted to the server computer 1 using the application program allocated to the specific port number from the client computer 2, the communication between the server computer 1 and the client computer 2 is performed using the application program allocated to the port number identical with the specific number.

Accordingly, even under the environment where the use environment of the server computer 1 and the client computer 2 is restricted and hence, only the specific port number can be used, it is possible to make use of various applications using such a specific port number whereby it is possible to perform the smooth communication between the server computer 1 and the client computer 2.

What is claimed is:

1. A communication method which is performed between a server computer and a client computer which are connected with each other via an electronic communication network, the communication method comprising the steps of:
transmitting a request signal from the client computer to the server computer using an application allocated to a specific port number number;
transmitting any one of a plurality of application programs allocated to a port number identical with the specific port number from the server computer which receives the request signal to the client computer using the port number; and
performing the communication between the server computer and the client computer using the application program.

2. A server computer which performs a communication with a client computer via an electronic communication network, wherein when the server computer receives a request signal using an application allocated to a specific port number from the client computer, any application program out of a plurality of application programs allocated to a port number identical with the specific port number is transmitted to the client computer, and the server computer performs a communication with the client computer using the application program.
